(19) United States
(12) Patent Application Publication
(10) Pub. No.: US 2025/0236000 A1
(43) Pub. Date: Jul. 24, 2025

(54) ADJUSTABLE FOAM-PENETRATING NAIL GUN WITH TIP LOCKING MECHANISM

(71) Applicant: LOUISIANA-PACIFIC CORPORATION, NASHVILLE, TN (US)

(72) Inventors: NEIL FREIDBERG, LEBANON, TN (US); BRIAN EDMISTON, NASHVILLE, TN (US); CHUN-CHI LAI, TAICHUNG CITY (TW)

(21) Appl. No.: 18/799,775

(22) Filed: Aug. 9, 2024

Related U.S. Application Data
(60) Provisional application No. 63/571,385, filed on Mar. 28, 2024.
(60) Provisional application No. 63/622,457, filed on Jan. 18, 2024.
(60) Provisional application No. 63/611,126, filed on Dec. 16, 2023.
(60) Provisional application No. 63/650,959, filed on May 23, 2024.

(51) Int. Cl. B25C 1/04; E04C 2/296

(52) U.S. Cl. CPC B25C 1/047; E04C 2/296

(57) ABSTRACT

An improved nail gun with the standard gun tip is replaced with a hollow sheath tip or housing through which a hollow insertion driver or sheath extends. The outmost portion of the insertion driver penetrates attached material, such as a foam layer, on the surface of a multi-layer panel product, such as, but not limited to, a structural sheathing panel. The outermost end of the insertion driver comes into contact with the panel surface, and the user operates the gun to drive a nail or other fastener into the panel. The insertion driver is of a length suitable to fully penetrate the foam layer so that the head of the nail is properly seated on the panel surface, and also protects the attached material in the area from being broken or damaged by the pneumatic action of the gun.

This application claims benefit of and priority to U.S. Provisional Applications No. 63/611,126, filed Dec. 16, 2023, No. 63/622,457, filed Jan. 18, 2024, No. 63/571,385, filed Mar. 28, 2024, and No. 63/540,959, filed May 23, 2024, all of which are incorporated herein by specific reference for all purposes.

### FIELD OF INVENTION

This invention relates to a nail gun adapted to nail through variable depths of insulating material, such as an insulating foam layer, on the surface of a wood or manufactured wood panel.

### BACKGROUND OF THE INVENTION

Building wall and roof assemblies are typically layers of several materials, each performing a single function, that are installed separately on the site in which the building is being constructed. Compatibility between the various layers creates challenges not only for the designer, but also for the installers.

A typical layer in most such assembles in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include fire retardants, insect repellants, moisture resistance, fungus resistance, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability, and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above described type are produced with bending, tensile strengths and face strengths comparable to those of commercial softwood plywood.

Building wall and roof assemblies typically are constructed by attaching several panels of the above described type as to an underlying supporting structure frame as “sheathing.” These sheathing panels are often placed in a pattern with the edge of each panel contacting or positioned close to adjacent panels, thereby forming a substantially continuous flat surface. In certain types of construction, the panels (and other construction materials) may be required under applicable building to meet certain weather resistance or water resistance requirements.

In prior art applications, a manufactured wood panel is installed as sheathing at a job or construction site. After installation, a code-approved water resistant barrier (WRB) system or material is applied. Examples of these WRB systems include housewrap (e.g. Tyvek, Typar), peel-and-stick membranes, or a WRB fluid or liquid applied to the installed panel. However, these systems all rely upon skilled labor for installation at the job. In addition, many of the systems cannot be installed during inclement weather, and require the installed sheathing to be free of defects and provide a clean surface free of debris in order to achieve proper adhesion between the panel and the WRB. As a result, all of these systems can be problematic to install on a job site, and often result in improper installation causing failures in the building “envelope,” leading to problems such as moisture instruction or mold or mildew growth. Examples of installation failures include, but are not limited to, reverse lapping, inconsistent thickness of the applied WRB, and improper adhesion of the WRB to the panel. These prior art systems also increase safety risks at the job site, since the installer must handle bulky or clumsy materials at potentially high elevations for long periods of time. Installation of a WRB at a factory prior to transport and installation in the field also is known.

In many locations, some form of insulation is often required in a roof or wall construction, helping to protect and maintain the interior of a structure from high or low temperatures. Insulation typically is added during or after installation of structural panels. Installation of an insulation layer to the interior side of a panel at a factory prior to transport and installation in the field also is known.

However, the application of multiple barrier layers or other layers of various types to both faces of a panel substantially increases the cost and complexity of the manufacturing process. For example, the layers typically require separate application, curing and application before additional layers are added.

A wood or wood composite product panel that provides insulation and air and bulk water resistance in a single layer preapplied at the factory, and without the need for a prior art WRB system to be applied at the job or construction site, is disclosed in U.S. patent application Ser. No. 18/238,746, filed Aug. 28, 2023, which is incorporated herein in its entirety by specific reference for all purposes.

Standard nail guns known in the prior art are typically limited in scope, providing a single solution for mechanically attaching similar and dissimilar materials, such as sheathing panels, to studs or framing elements. These guns are designed to seat a nail or similar fastener close to the surface of the panel, plus or minus a minor factor of error due to air pressure density of the substrate and similar conditions. However, these guns do not have the ability to insert a nail through different depths or thicknesses of laminated insulated material, such as foam insulation, attached to the surface of the panel. In some cases, such as where the attached material has a substantial thickness, the nail does not adequately penetrate the thickness of the attached material to be properly seated close to the surface of the panel. In other cases, the pressure and force associated with driving the nail cause significant damage and breakage of the attached materials.

Accordingly, what is needed is a modified nail gun with the ability to properly seat a nail to the surface of a structural or similar panel through different thickness of attached material.

### SUMMARY OF INVENTION

In various exemplary embodiments, the present invention comprises an improved nail gun, such as a pneumatic nail gun with a plurality of nails stored in a magazine, wherein the user uses a trigger to cause a nail to be driven with force from the front end of the gun. In the present invention, the standard gun tip is replaced with a hollow tip sheath or housing through which a hollow insertion driver or sheath extends. The outmost portion of the insertion driver penetrates the attached material on the surface of a multi-layer panel product, such as, but not limited to, as structural sheathing panels with a foam layer attached to one or both faces. The outermost end of the insertion driver comes into contact with the panel surface, and the user operates the gun to drive the nail (or other fastener) into the panel. The insertion driver is of a length suitable to fully penetrate the attached material (e.g., foam layer) so that the head of the nail is properly seated on the panel surface, and also protects the attached material in the area from being broken or damaged (e.g., pieces of foam being blown off the panel when the pneumatic gun operates).

Dimensions of insertion drivers may vary depending on the types and dimensions of nails and fasteners, and on the types and dimensions of attached material, as well as the properties of the underlying panel or material into which the fastener is to be inserted. For example, the length of the insertion driver will vary depending on the thickness of the particular foam layer or attached material. Insertion drivers may be changed so the length is suitable for a particular thickness of foam material.

### BRIEF DESCRIPTION OF THE DRAWINGS

FIG. 1 shows a diagram of a modified nail gun with a detail view of the adjustable sheathing on the tip.

FIGS. 2A-B show detail views of the adjustable sheath at different lengths, adjusted in half-inch increments.

FIGS. 3A-B shows additional detail views of the adjustable sheath at different lengths, with more precise length adjustments between the half-inch increments.

FIG. 4 shows a detail side view of a tip.

FIGS. 5A-D show side view of tips for specific foam depths.

FIG. 6 shows a perspective view of a tip.

FIG. 7 shows the steps for removing a tip from a spring-lock mechanism.

FIGS. 8-9 show detailed views of a tip locking mechanism.

FIG. 10 shows side view of pads for specific foam depths.

### DETAILED DESCRIPTION OF EXEMPLARY EMBODIMENTS

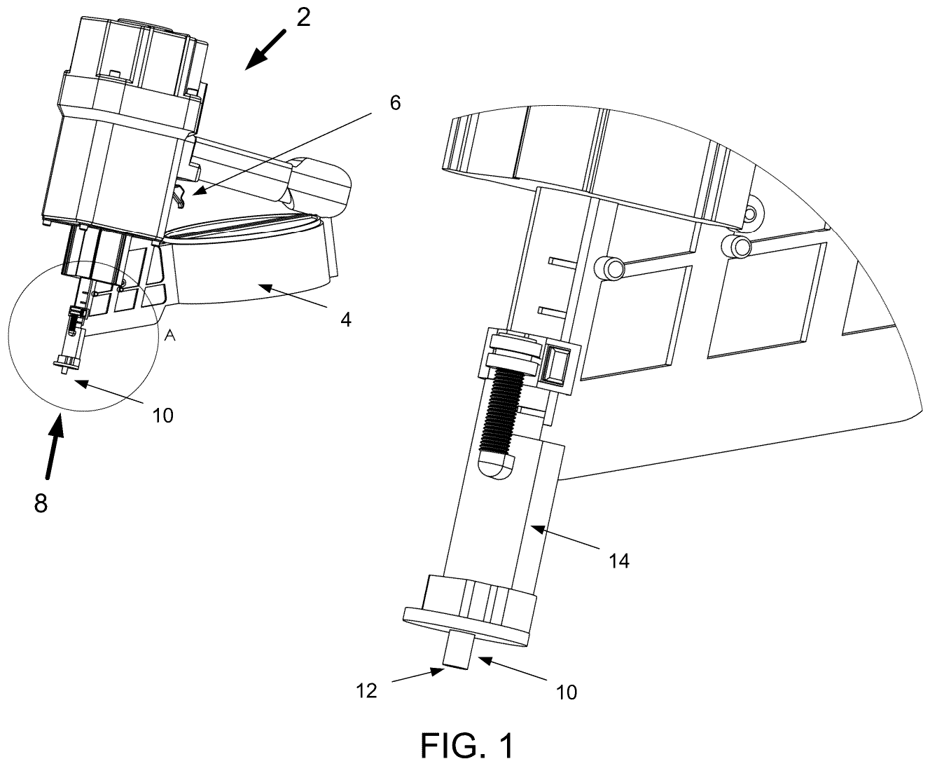

In various exemplary embodiments, as seen in FIGS. 1-3, the present invention comprises an improved nail gun 2, such as a pneumatic nail gun with a plurality of nails stored in a magazine 4, wherein the user uses a trigger 6 to cause a nail to be driven with force from the front end 8 of the gun. In the present invention, the standard gun tip is replaced with a hollow tip sheath or housing 14 through which a hollow insertion driver or sheath 10 extends. The outermost end of insertion driver 10 penetrates the attached material on the surface of a multi-layer panel product, such as, but not limited to, as structural sheathing panels with a foam layer attached to one or both faces. The outermost end 12 of the insertion driver 10 comes into contact with the panel surface, and the user operates the gun to drive the nail (or other fastener) into the panel. The insertion driver 10 is of a length suitable to fully penetrate the attached material (e.g., foam layer) so that the head of the nail is properly seated on the panel surface, and also protects the attached material in the area from being broken or damaged (e.g., pieces of foam being blown off the panel when the pneumatic gun operates).

Dimensions of insertion drivers may vary depending on the types and dimensions of nails and fasteners, and on the types and dimensions of attached material, as well as the properties of the underlying panel or material into which the fastener is to be inserted. For example, the length of the insertion driver will vary depending on the thickness of the particular foam layer or attached material. Insertion drivers may be changed so the length is suitable for a particular thickness of foam material.

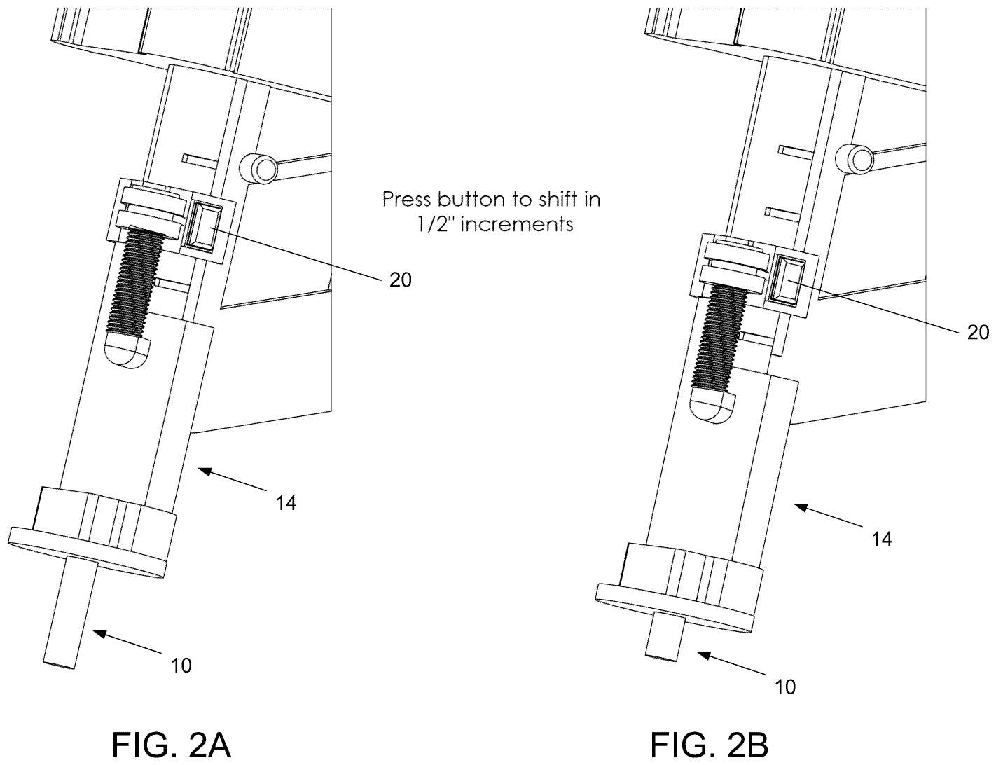

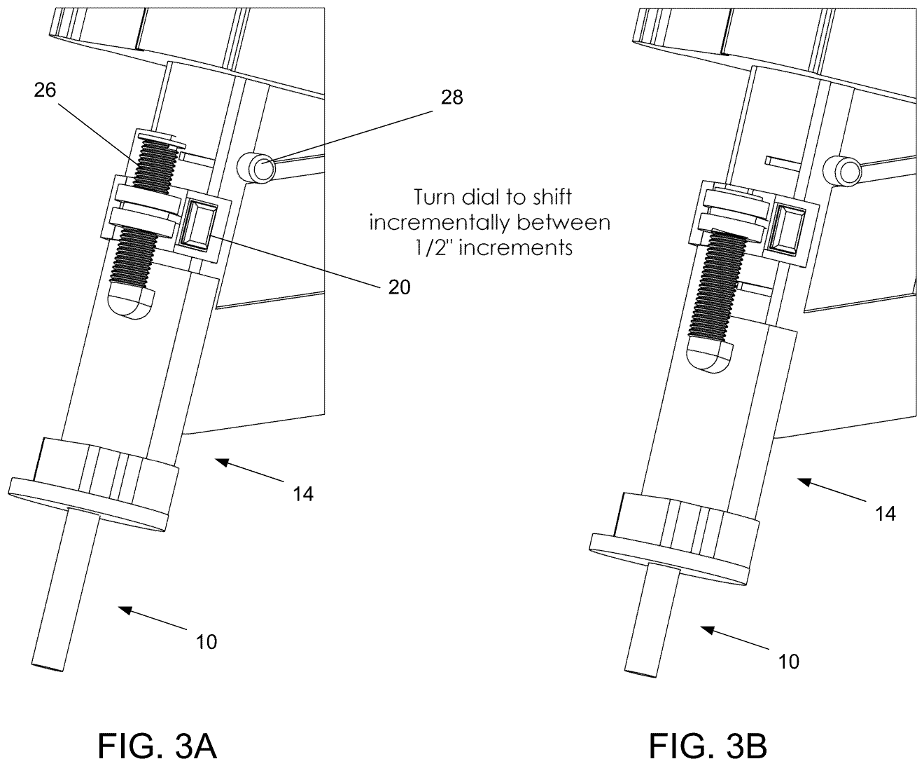

FIGS. 2A-B and 3A-B show an adjustable insertion driver 10 and tip sheath 14 with a fixed range of lengths. The end of the gun is larger than a prior art nail gun in order to house a longer driving mechanism. As seen in FIGS. 2A and 2B, the effective length of the adjustable insertion driver and the position of the tip sheath may be adjusted by pressing a release button 20 and moving the tip sheath in a linear fashion in pre-set increments (e.g., half-inch increments). The sheath slides along a guide rail. This allows for easy adjustment of the sheath length to certain common thicknesses (e.g., flat/flush, ½ inch, 1 inch, 1½ inch, 2 inch, 2½ inch, 3 inch, 3½ inch, and so on). FIGS. 3A and 3B show how the respective positions and length may be more precisely adjusted between the pre-set increments of FIGS. 2A and 2 B with a dial 28. The dials turns screw 26, which causes the tip sheath to gradually move up or down with respect to the insertion driver.

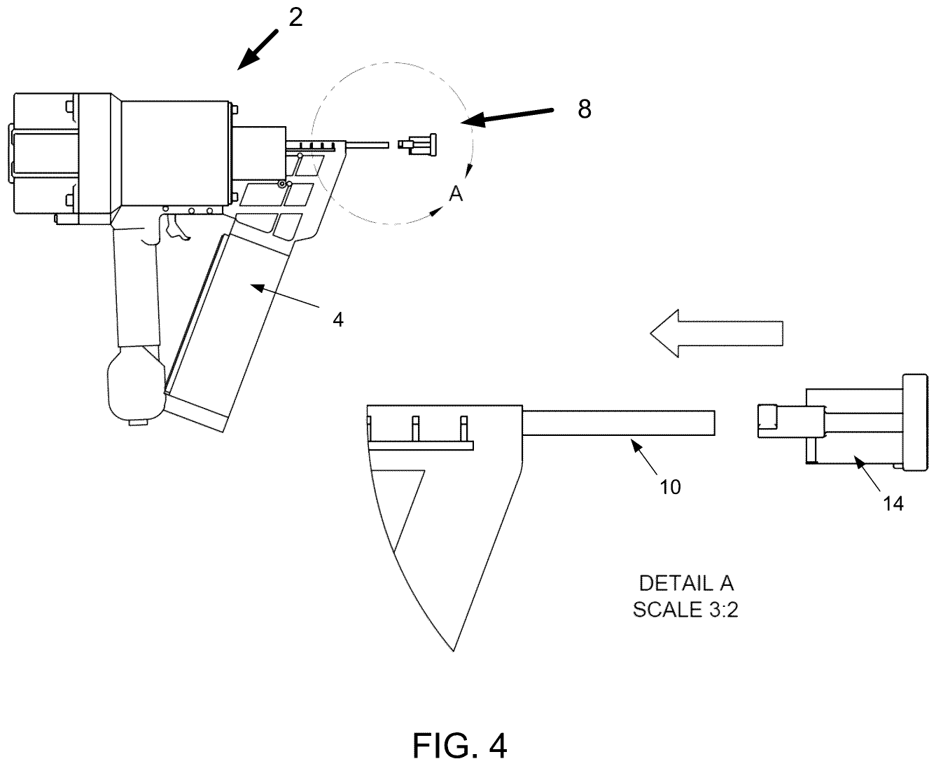

FIG. 4 shows an embodiment where a hollow tip sheath or housing 14 is inserted over an insertion driver 10. The tip sheath 14 may removably fastened so various tips of different sizes and configurations can be replaced and used. The tips may be held in place by a screw, snap-lock, spring-lock, or similar holding means.

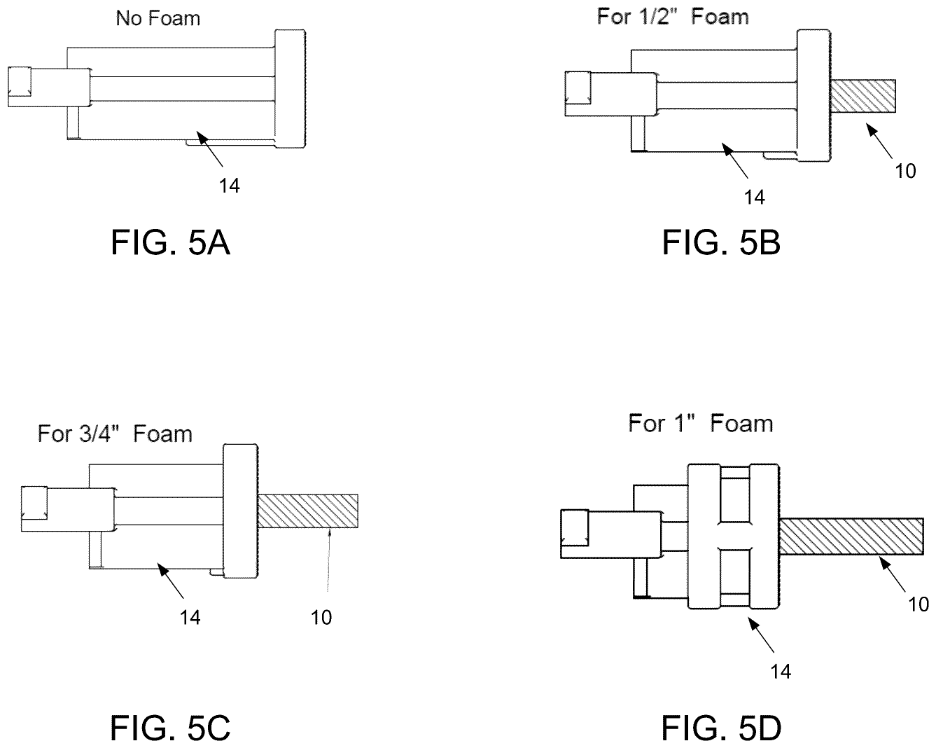

FIGS. 5A-D show examples of exchangeable gun tips 14 of various sizes and configurations. Tips are removably fastened and thus may be changed, with different tips configured for different depths of foam, or different ranges of depths of foam. For example, a tip may be configured for a fixed depth, such as, but not limited to, one of the common thicknesses (e.g., no foam, ½ inch, ¾ inch, 1 inch, 1½ inch, 2 inch, 2½ inch, 3 inch, 3½ inch, and so on). Different tips would be used for foam of a different depths. Likewise, an adjustable tip may be configured for a certain range of depths, and different adjustable tips would be used with different ranges for foams of different depths outside the range of the first adjustable tip.

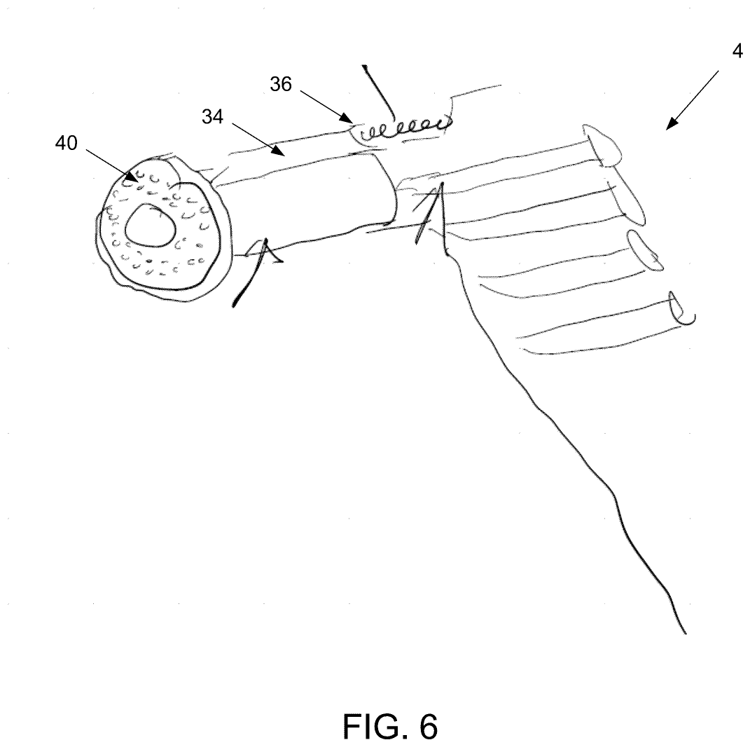

As seen in FIGS. 5 and 6, the tips may be attached to the nail gun by a clip, screw, bolt, rod, or similar means (e.g., a screw may be inserted into a threaded hole or slot 34 on the tip. A spring 36 may be used in conjunction with the screw or similar means to facilitate fastening and release may be used, as seen in FIG. 6.

The changeable tips allow the user to change tips to go from a standard nail gun to one or more special types of nail guns for use in installing a variety of foam or fiberglass panels allowing for full shear of the foam/fiberglass to the OSB or other substrate for the panel without a reduction in strength of the panel.

In some embodiments, the end surface 40 of the gun tip surrounding the base of the tip sheath 14 may be knurled, textured, or patterned so as to provide a more secure surface (i.e., higher coefficient of friction) in contact with the surface of the foam layer, or other attached material that may have a smooth or slick outer surface.

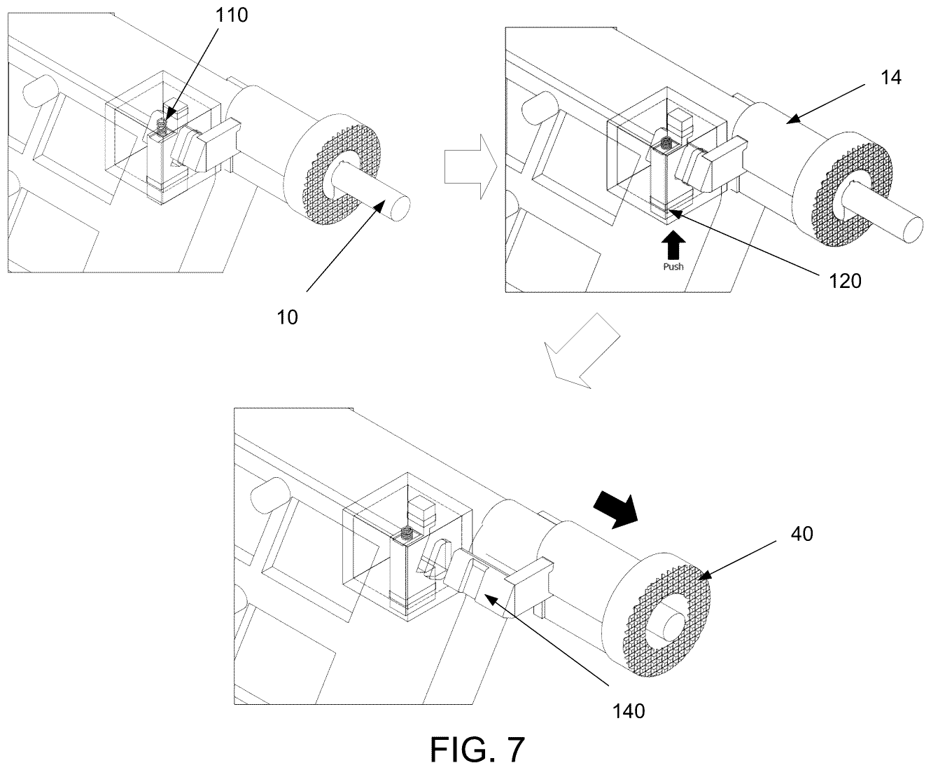

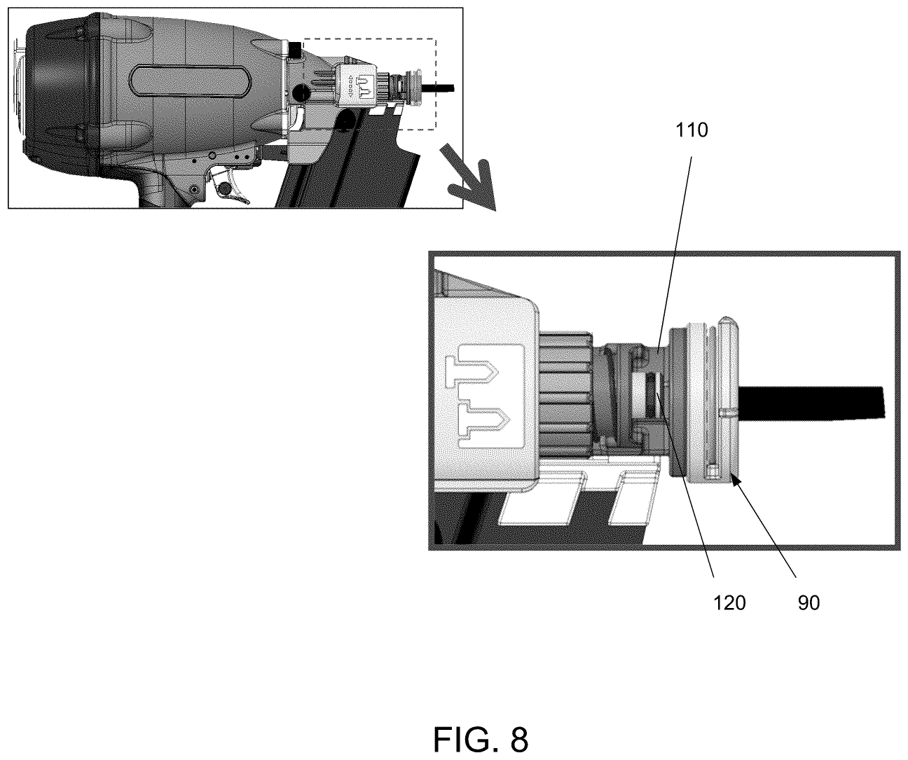

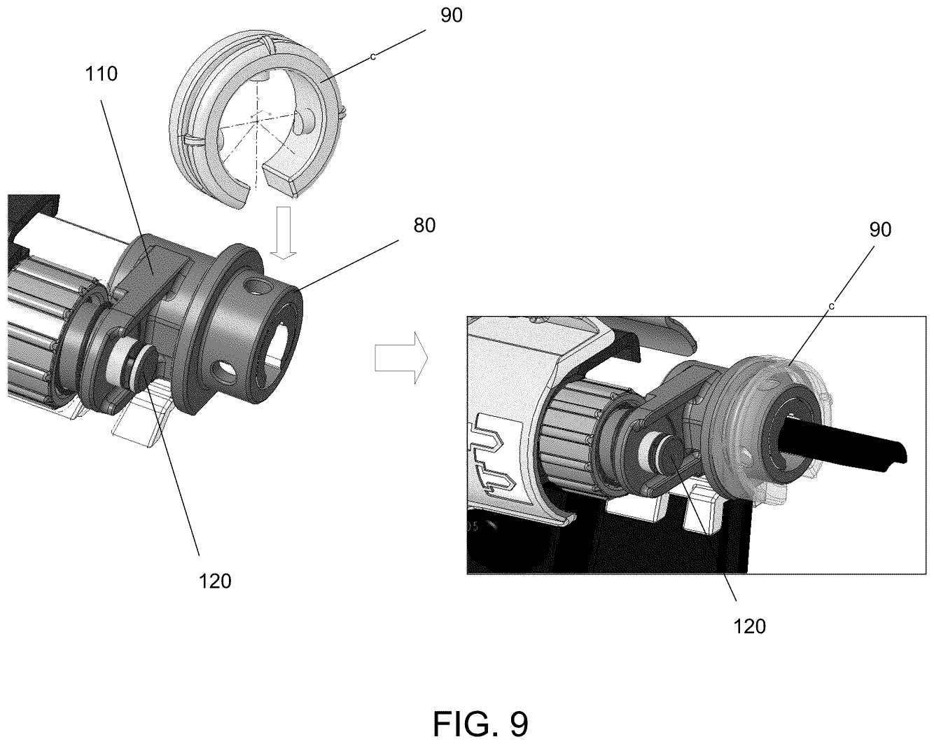

FIGS. 7-9 show an embodiment of a locking mechanism with a spring clip 110 for replaceable tips and/or sheathes/blades. The spring clip 110 stays in a locked position until the release button 120 is pressed, which deactivates the spring clip locking mechanism, releasing the locking arm or extension 140 from the tip sheath allowing the user to quickly remove the tip. When the replacement tip is inserted into the mechanism, the locking arm 140 automatically inserts into the spring clip lock, thereby automatically engages the tip and holding it securely in place.

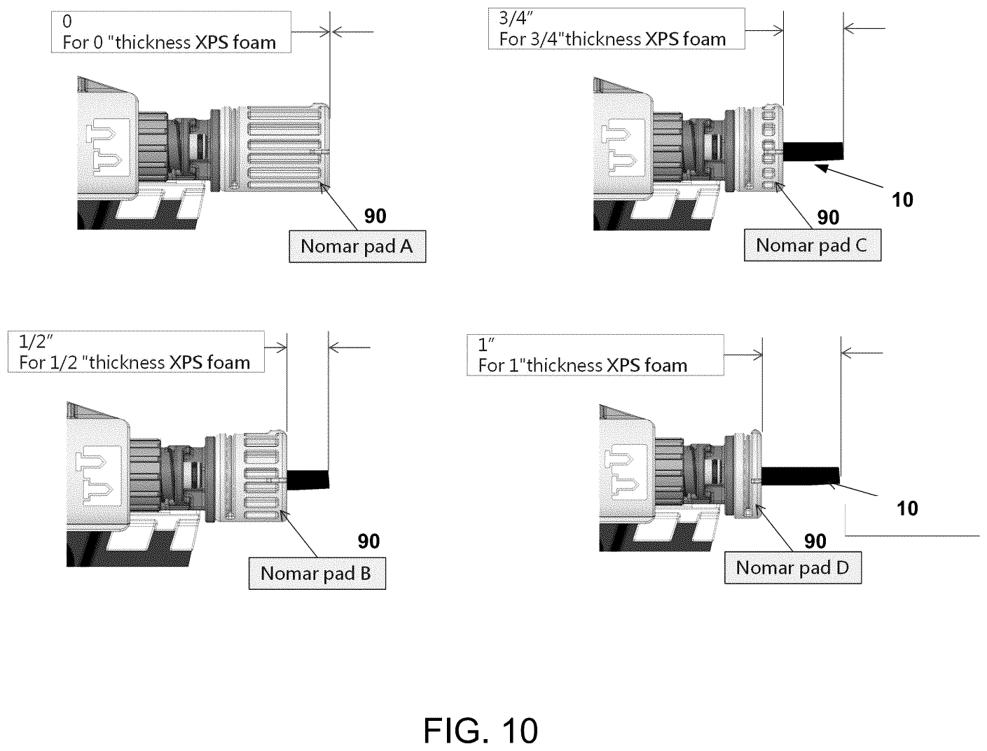

In several embodiments, a ring-shaped pad or protector 90 snap-fits onto a nose piece 80. The pads or protectors generally have a constant outer diameter with varying thicknesses. Pads with appropriate thicknesses can then be matched to different foam thicknesses, as seen in FIG. 10. These can be used as an alternative means to adjusting the effective length of the insertion driver 10.

In additional embodiments, the modified tip apparatus described above is designed to be retro-fit to a prior art or standard nail gun.

Accordingly, the present invention allows the user to use a single nail gun while framing to accommodate panels with different thicknesses and types of attached material (e.g., less dense material attached to OSB structural panels) without having to have different nail-guns on site. This reduces the costs of tools for the framer/builder.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A nail gun for installing panels with foam or other attachable materials, comprising:
a nailgun body with a handle, a trigger, a magazine for holding nails or other fasteners, and a front end from which a nail or other fastener is ejected the trigger is pulled;
an adjustable tip located on the front end of the nailgun body, the adjustable tip comprising a cylindrical tip sheath with a first end, a second end, and an interior with a channel or hole extending from the second end to the first end, wherein the tip sheath is attached at its second end to the nailgun body;
an insertion driver with a distal end and a proximate end, the insertion driver extending through the channel or hole of the tip sheath, wherein the distal end extends a distance beyond or even with the first end of the tip sheath;
a locking arm extending from the tip sheath and configured to releasably engage a spring-clip lock on the nailgun body, wherein the spring-clip lock when engaged hold the tip sheath in a fixed position, and the tip sheath is removable when the spring-clip lock is released;
wherein the distal end distance is adjustable.

2. The nail gun of claim 1, wherein the distal end distance is adjustable in fixed increments.

3. The nail gun of claim 1, wherein the distal end distance is continuously adjustable within a fixed range.

4. The nail gun of claim 1, wherein the distal end distance is adjustable by movement of at least a portion of the tip sheath with respect to the insertion driver.

5. The nail gun of claim 1, wherein at least a portion of the tip sheath sliding moves linearly along a guide rail with stop at preset thicknesses.

6. The nail gun of claim 1, wherein the tip sheath is removably attached to the nailgun body.

7. The nail gun of claim 1, wherein the first end of the tip sheath is a flat surface.

8. The nail gun of claim 7, wherein the flat surface is knurled or textured.

9. The nail gun of claim 1, wherein the spring-clip lock is released by depressing a button on the nailgun body.

10. The nail gun of claim 1, further comprising a plurality of ring-shaped pads that removably attach to the first end of the tip sheath.

11. A system for fastening a sheathing panel with a foam layer, comprising:
a sheathing panel with a first face and a second face, wherein the first face is covered by a foam layer of a first thickness;
a pneumatic nailgun comprising
a nailgun body with a handle, a trigger, a magazine for holding nails or other fasteners, and a front end from which a nail or other fastener is ejected the trigger is pulled;
an adjustable tip located on the front end of the nailgun body, the adjustable tip comprising a cylindrical tip sheath with a first end, a second end, and an interior with a channel or hole extending from the second end to the first end, wherein the tip sheath is attached at its second end to the nailgun body; and
an insertion driver with a distal end and a proximate end, the insertion driver extending through the channel or hole of the tip sheath, wherein the distal end extends a distance beyond or even with the first end of the tip sheath; and
a locking arm extending from the tip sheath and configured to releasably engage a spring-clip lock on the nailgun body, wherein the spring-clip lock when engaged hold the tip sheath in a fixed position, and the tip sheath is removable when the spring-clip lock is released;
wherein the distal end distance is adjustable to match the thickness of the foam, so that when the nailgun is operated to drive a nail into the sheathing panel, the insertion driver extends through the foam layer such that the distal end is in contact with the sheathing panel.

12. The system of claim 11, wherein when the nailgun is operated to drive a nail into the sheathing panel, the foam layer is substantially undamaged.

13. The system of claim 11, wherein when the nailgun is operated to drive a nail into the sheathing panel, a portion of the foam layer remains above the nail after being driven into the sheathing panel.

14. The system of claim 11, when the nailgun is operated to drive a nail into the sheathing panel, the first end of the tip sheath is in contact with the foam layer.
